(19) United States
(12) Patent Application Publication
(10) Pub. No.: US 2024/0026061 A1
(43) Pub. Date: Jan. 25, 2024

(54) POLYETHERESTER POLYOL AND USE THEREOF FOR PRODUCING POLYURETHANE RIGID FOAM MATERIALS

(71) Applicant: BASF SE, Ludwigshafen am Rhein (DE)

(72) Inventors: Jian Feng XU, Shanghai (CN); Shidhu Easwara Menon, Singapore (SG); Yong Hao Zhang, Shanghai (CN); Zu Bao Nie, Shanghai (CN)

(73) Assignee: BASF SE, Ludwigshafen am Rhein (DE)

(21) Appl. No.: 18/256,527

(22) PCT Filed: Dec. 2, 2021
(86) PCT No.: PCT/EP2021/083997

§ 371 Date: Jun. 8, 2023

(30) Foreign Application Priority Data
Dec. 10, 2020 (WO) PCT/CN2020/135225

(51) Int. Cl. C08G 18/42; C08G 18/40; C08G 18/46; C08G 18/48; C08G 18/50; C08G 18/18; C08G 18/20; C08G 18/12; C08G 18/08; C08J 9/00; C08J 9/12; C08J 9/14

(52) U.S. Cl. CPC C08G 18/4252; C08G 18/4018; C08G 18/4213; C08G 18/4615; C08G 18/4816; C08G 18/5021; C08G 18/1816; C08G 18/2036; C08G 18/12; C08G 18/14; C08J 9/0061; C08J 9/125; C08J 9/141; C08G 2101/00

(57) ABSTRACT

A polyetherester polyol is synthesized from reactants including a) aromatic acid or aromatic anhydride or a mixture thereof, and b) OH-functional starter molecules which contain alcoholamine or amine-initiated polyether polyol. Corresponding rigid polyurethane foams produced with the polyetherester polyol are useful for insulation used in appliance applications.

### TECHNICAL FIELD

The present invention relates to a polyetherester polyol synthesized by reactants comprising a) aromatic acid or aromatic anhydride or the mixture thereof and b) OH-functional starter molecules which comprise alcoholamine or amine-initiated polyether polyol. And also rigid polyurethane foams obtained there with and use thereof for insulation used in the appliance application.

### BACKGROUND

Rigid polyurethane (PU) foams are obtainable in a known manner by reacting organic polyisocyanates with one or more compounds having two or more reactive hydrogen atoms, preferably polyether and/or polyester alcohols (polyols), in the presence of blowing agents, catalysts and optionally auxiliaries and/or added-substance materials.

The isocyanate-based production of rigid PU foams typically utilizes polyols having high functionalities and a low molecular weight in order to ensure a very high degree of crosslinking for the foams. The preferably employed polyether alcohols usually have a functionality of 4 to 8 and a hydroxyl number in the range between 300 to 600, in particular between 400 and 500 mg KOH/g. It is known that polyols having a very high functionality and hydroxyl numbers in the range between 300 and 600 have a very high level of viscosity. It is further known that such polyols are comparatively polar and thus have poor solubility for customary blowing agents, in particular hydrocarbons such as pentanes, in particular cyclopentane.

Ortho-toluenediamine (ortho-TDA) started polyether polyol is widely used because it is helpful to reduce thermal conductivity and improve the compatibility with hydrocarbon blowing agent. Currently the price of ortho-TDA increased a lot and the supply is shortage. However, further reduction of the thermal conductivity and foam density is being required by appliance industry.

EP 1923417B1 discloses that a polyol component comprising polyetherester polyols based on fat containing no OH groups, such as soya oil, have improved blowing agent solubilities and that the rigid foams produced therefrom have a short demolding time. However, the thermal insulation property is not satisfied.

WO2013053555A2 describes polyester-polyether polyols suitable for blending with other polyols or other materials mutually compatible with the polyester polyols to achieve polyurethane and polyisocyanurate products. The polyester-polyether polyols produced by the reaction of phthalic anhydride with an alcohol having a nominal functionality of 3 and a molecular weight of 90 to 500 under conditions to form a phthalic anhydride half-ester; and then alkoxylating the half-ester to form a polyester-polyether polyol having a hydroxyl number of from 200 to 350. The polyols can reduce thermal conductivity, however the synthesis process is complicated.

Therefore, it is still required to provide an aromatic containing polyetherester polyols suitable for rigid foam applications wherein the polyols have good hydrocarbon compatibility and a functionality greater than 3 which are economical to produce and can be converted into cellular foams having excellent properties.

### SUMMARY OF THE PRESENT INVENTION

An object of this invention is to overcome the problems of the prior art discussed above and to provide a class of polyetherester polyols having an average functionality of at least 3 and an OH number of 50 to 800 mg KOH/g, preferably 100 to 600 mg KOH/g, more preferably 300 to 500 mg KOH/g.

In one aspect, the invention is to a polyetherester polyol synthesized by reactants comprising:
a) aromatic acid or aromatic anhydride or the mixture thereof
b) OH-functional starter molecules
   wherein the OH-functional starter molecules b) comprise alcoholamine or amine-initiated polyether polyol.

In a further embodiment, the alcoholamine is an aliphatic alkanolamine selected from ethanolamine, diethanolamine, triethanolamine, triisopropanolamine, diisopropanolamine and monoisopropanolamine.

In another embodiment, the amine-initiated polyether polyol is an aliphatic amine-initiated polyether polyol, wherein the aliphatic amine is selected from ethylenediamine, diethylenetriamine, triethylenetetramine and tetraethylenepentamime.

In a preferred embodiment, the aromatic acid is phthalic acid and the aromatic anhydride is phthalic anhydride.

In another preferred embodiment, the OH-functional starter molecules (b) further comprise other glycol, glycerin or polyether polyol.

In a more preferred embodiment, the molar ratio of reactant a) to reactant b) is from 1:1 to 1:3, preferably 1:1 to 1:2.

The invention also relates to a process for producing rigid polyurethane foams by reaction of
A) organic or modified organic polyisocyanates or mixtures thereof,
B) one or more polyetherester polyols according to any of described above,
C) optionally further polyester and/or polyether polyols,
D) one or more blowing agents,
E) catalysts, and
F) optionally further auxiliaries and/or additives.

In a further aspect, the invention relates to a rigid polyurethane foam made using such polyetherester polyols.

In a further aspect, the invention relates to a rigid polyurethane foam used as an insulation or used in the appliance application.

It has been surprisingly found in this application that, by using the new polyetherester polyols which have good hydrocarbon compatibility, the rigid polyurethane foam shows good performance in terms of thermal conductivity, demolding and mechanical strength.

### DETAILED DESCRIPTION OF THE PRESENT INVENTION

Unless defined otherwise, all technical and scientific terms used herein have the meaning commonly understood by a person skilled in the art to which the invention belongs. As used herein, the following terms have the meanings ascribed to them below, unless specified otherwise.

As used herein, the articles “a” and “an” refer to one or to more than one (i.e., to at least one) of the grammatical object of the article. By way of example, “an element” means one element or more than one element.

Unless otherwise identified, all percentages (%) are “percent by weight”.

Unless otherwise identified, the temperature refers to room temperature and the pressure refers to ambient pressure.

Unless otherwise identified, the solvent refers to all organic and inorganic solvents known to the persons skilled in the art and does not include any type of monomer molecular.

The polyetherester polyols in the present invention are synthesized by reactants comprising:
a) aromatic acid or aromatic anhydride or the mixture thereof
b) OH-functional starter molecules
   wherein the OH-functional starter molecules b) comprise alcoholamine or amine-initiated polyether polyol.

The aromatic acid or aromatic anhydride in the present polyetherester polyol are derived primarily from phthalic acid or phthalic anhydride.

The OH-functional starter molecules are generally comprising an alcoholamine or a polyether polyol which initiated form amine. The alcoholamine is usually aliphatic alkanolamines and the examples of such aliphatic alkanolamines include ethanolamine, diethanolamine, triethanolamine (TEOA), triisopropanolamine, diisopropanolamine and monoisopropanolamine. The polyether polyols are obtained by the alkoxylation of suitable amine (initiators) with a C2 to C4 alkylene oxide (epoxide), such as ethylene oxide (EO), propylene oxide (PO), 1,2- or 2,3-butylene oxide, tetramethylene oxide or a combination of two or more thereof. In some embodiments, propylene oxide will be the sole alkylene oxide used in the production of the polyol. When an alkylene oxide other than PO is used, it is preferred the additional alkylene oxide, such as ethylene or butylene oxide is fed as a co-feed with the PO or fed as an internal block. Catalysis for this polymerization of alkylene oxides can be either anionic or cationic, such as an amine, preferably dimethylethanolamine or imidazole, more preferably imidazole, as alkoxylation catalyst.

In some embodiments, alcoholamine initiators such as triethanolamine are fed with catalyst of potassium hydroxide into a stainless-steel reactor equipped with a stirrer, nitrogen inlet tube at 80° C. to 90° C. Under vacuum of 1330 Pa, the reaction mass is then heated at 110° C. to 120° C. Water resulting from the self-polycondensation of alcoholamine is condensed and collected, usually it takes 1 to 2 hours to form a potassium alcoholate. The volume of water is a direct measure of the extent of polycondensation reaction. Then, under a protective atmosphere of nitrogen, the potassium alcoholate of above is heated at 100° C. to 120° C. and the PO (depending on the desired hydroxyl number) are added assure a pressure of 0.3 to 0.8 MPa at the reaction temperature. After the addition of the calculated quantity of PO, the reaction mass was maintained under stirring at 100° C. to 120° C. around 2 to 4 hours to get the alcoholamine initiated polyetherol for further reaction with aromatic acid or aromatic anhydride.

The polypropylene oxide based polyether polyol, generally has a molecular weight of from 200 to 800. In one embodiment, the molecular weight is from 200 to 600. In a further embodiment the molecular weight is from 200 to 500.

The suitable amine initiators for production of polyether polyol reactant have a functionality of above 2. As used herein, unless otherwise stated, the functionality refers to the nominal functionality. Non-limiting examples of such initiators include, for example, ethylenediamine, diethylenetriamine, triethylenetetramine and tetraethylenepentamime.

In some embodiments, besides alcoholamine or amine-initiated polyether polyol, the reactant b) could further contain other OH-functional starter molecules, for example, glycol, glycerin or another conventional used polyether polyol. The amount of the other starter molecules, based on the total weight of the polyetherester polyols, is preferably from 0 to 60% by weight, particularly preferably from 5 to 30% by weight, and in particular from 10 to 25% by weight.

The molar ratio of reactant a) to reactant b) is generally from 1:1 to 1:3. In a further embodiment the molar ratio is from 1:1 to 1:2.

In various embodiments, the polyetherester polyols have a hydroxyl number of from about 50 mg KOH/g to about 800 mg KOH/g. As used herein, a hydroxyl number is the milligrams of potassium hydroxide equivalent to the hydroxyl content in one gram of the polyol or other hydroxyl compound. In some embodiments, the resultant polyetherester has a hydroxyl number of from about 100 mg KOH/g to about 600 mg KOH/g. In still other embodiments, the resultant polyetherester has a hydroxyl number of from about 300 mg KOH/g to about 500 mg KOH/g. The polyester-polyether may have an average functionality of at least 3. As used herein, the average functionality is the number of isocyanate reactive sites on a molecule, and may be calculated as the total number of moles of OH over the total number of moles of polyol. In some embodiments, the polyetherester polyol has an average functionality of about 4.

The invention further provides a process for preparing rigid polyurethane foams by reaction of
A) organic or modified organic di- or polyisocyanates or mixtures thereof,
B) one or more polyetherester polyols according to any of described above,
C) optionally further polyether and/or polyester polyols,
D) one or more blowing agents,
E) catalysts, and
F) optionally further auxiliaries and/or additives.

Di- or Polyisocyanates A)

Compounds useful as organic di- or polyisocyanates A) include the familiar aliphatic, cycloaliphatic, araliphatic di- or polyfunctional isocyanates and preferably the aromatic di- or polyfunctional isocyanates. Said organic di- or polyisocyanates may optionally be in a modified state.

Specific examples include alkylene diisocyanates having 4 to 12 carbon atoms in the alkylene moiety, such as 1,12-dodecane diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate; cycloaliphatic diisocyanates such as cyclohexane 1,3-diisocyanate and cyclohexane 1,4-diisocyanate and also any desired mixtures thereof, 1-isocyanato-3,3,5-trimethyl-5-isocyanatomethylcyclohexane (IPDI), 2,4- and 2,6-hexahydrotolylene diisocyanate and also the corresponding isomeric mixtures, 4,4′-, 2,2′- and 2,4′-dicyclohexylmethane diisocyanate and also the corresponding isomeric mixtures, and preferably aromatic di- and polyisocyanates, for example 2,4- and 2,6-tolylene diisocyanates and the corresponding isomeric mixtures, 4,4′-, 2,4′- and 2,2′-diphenylmethane diisocyanate and the corresponding isomeric mixtures, mixtures of 4,4′- and 2,2′-diphenylmethane diisocyanates, polyphenyl polymethylene polyisocyanates, mixtures of 2,4′-, 2,4′- and 2,2′-diphenylmethane diisocyanates and polyphenyl polymethylene polyisocyanates (crude MDI) and mixtures of crude MDI and tolylene diisocyanates. Organic di- or polyisocyanates are employable singly or in the form of their mixtures.

Preferred polyisocyanates are tolylene diisocyanate (TDI), diphenylmethane diisocyanate (MDI) and especially mixtures of diphenylmethane diisocyanate and polyphenylene polymethylene polyisocyanates (polymer MDI or PMDI).

Modified di- or polyfunctional isocyanates, i.e., products obtained by converting organic polyisocyanates chemically, are frequently also used. Examples are polyisocyanates comprising ester, urea, biuret, allophanate, carbodiimide, isocyanurate, uretdione, carbamate and/or urethane groups.

A very particularly preferred way to prepare the rigid polyurethane foams of the present invention involves using polymer MDI, e.g., Lupranat® M20 from BASF SE.

Other possible isocyanates are given by way of example in “Kunststoffhandbuch, Band 7, Polyurethane” [Plastics handbook, volume 7, Polyurethanes], Carl Hanser Verlag, 3rd edition, 1993, chapters 3.2 and 3.3.2.

Polyether/Polyester Polyols C)

It is possible to use polyether polyols and polyester polyols, or a mixture thereof.

The polyols preferably used are polyether polyols with a molecular weight between 500 and 6000, preferably from 300 to 2000, more preferably from 300 to 1000, OH value between 20 and 800 mg KOH/g, preferably from 50 to 600 mg KOH/g, and/or polyester polyols with molecular weights between 200 and 1000, preferably from 200 to 800, more preferably from 200 to 600, OH value between 60 and 650 mg KOH/g, preferably from 120 to 500 mg KOH/g. The following polyols are preferred in the invention: LUPRANOL® 2095 (BASF), LUPRANOL® 2090 (BASF), LUPRANOL® VP 9346 (BASF), LUPRANOL® VP 9393 (BASF), LUPRAPHEN® 3907 (BASF), LUPRAPHEN® 3915 (BASF), STEPANPOL® PS 3152, PS 2412, PS 1752 (Stepan Company).

The polyether polyols (PEOL) that can be used in the invention are produced by known processes. By way of example, they can be produced from one or more alkylene oxides having from 2 to 4 carbon atoms in the alkylene radical via anionic polymerization using alkali metal hydroxides, such as sodium hydroxide or potassium hydroxide, or using alkali metal alcoholates, such as sodium methoxide, sodium ethoxide or potassium ethoxide, or potassium propoxide as catalysts, with addition of at least one starter molecule which comprises from 2 to 8 reactive hydrogen atoms, or via cationic polymerization using Lewis acids, such as antimony pentachloride, boron fluoride etherate, etc., or bleaching earth as catalysts.

Examples of suitable alkylene oxides are propylene 1,2-oxide, butylene 1,2-oxide or butylene 2,3-oxide, styrene oxide, and preferably ethylene oxide and propylene 1,2-oxide. The alkylene oxides can be used individually, in alternating succession, or as a mixture.

Examples of starter molecules that can be used are ethylene glycol, propylene glycol, water, glycerine, sorbitol, sucrose, tetrahydrofuran.

Polyester polyols (PESOL) can by way of example be produced from dicarboxylic acids having from 2 to 12 carbon atoms, preferably from 4 to 6 carbon atoms, and from polyhydric alcohols. Examples of dicarboxylic acids that can be used are: aliphatic dicarboxylic acids, such as succinic acid, glutaric acid, adipic acid, suberic acid, azelaic acid, and sebacic acid, and aromatic dicarboxylic acids, such as phthalic acid, isophthalic acid, and terephthalic acid. The dicarboxylic acids can be used individually or in the form of mixtures, e.g. in the form of a mixture of succinic, glutaric, and adipic acid. Examples of polyhydric alcohols are glycols having from 2 to 10, preferably from 2 to 6, carbon atoms, e.g. ethylene glycol, diethylene glycol, 1,4-butanediol, 1,5-pentanediol, 1,6-hexanediol, 1,10-decanediol, 2,2-dimethyl-1,3-propanediol, 1,3-propanediol, and dipropylene glycol, triols having from 3 to 6 carbon atoms, e.g. glycerol and trimethylolpropane, and, as higher-functionality alcohol, pentaerythritol. The polyhydric alcohols can be used alone or optionally in mixtures with one another, in accordance with the properties desired.

The amount of the optional further polyether polyol and/or polyester polyol, based on the total weight of the reactant B) to F), is preferably from 0 to 60% by weight, particularly preferably from 5 to 55% by weight, and in particular from 10 to 45% by weight.

Blowing Agent D)

The blowing agent D) used according to the invention could be chemical and/or physical blowing agents in the art. Chemical blowing agents are compounds which form gaseous products through reaction with isocyanate, an example being water or formic acid. Physical blowing agents are compounds which have been dissolved or emulsified in the starting materials for polyurethane production and which vaporize under the conditions of polyurethane formation. By way of example, these are hydrocarbons, halogenated hydrocarbons, and other compounds, such as perfluorinated alkanes, and ethers, esters, ketones and/or acetals.

Chemical blowing agent used in this invention could be water and with preference from 1 to 3 wt %, with particular preference from 1.5 to 3.0 wt % and with very particular preference from 2.0 to 3.0 wt %, based on total weight of the reactant B) to F).

Suitable physical blowing agents which can be used preferably, are alkanes, such as heptane, hexane, n-pentane and iso-pentane, preferably technical grade mixtures of n- and iso-pentanes, n- and iso-butane and propane, cycloalkanes, such as cyclopentane and/or cyclohexane, ethers, such as furan, dimethyl ether and diethyl ether, ketones, such as acetone and methyl ethyl ketone, alkyl carboxylates, such as methyl formate, dimethyl oxalate and ethyl acetate. Mixtures of these low-boiling liquids with each other and/or with other substituted or unsubstituted hydrocarbons can also be used.

The amount used of physical blowing agent and/or of blowing agent mixture is from 10 to 20 parts by weight, preferably from 10 to 17 parts by weight, based on the total weight of the reactant B) to F).

These physical blowing agents are usually added to the polyol component of the system. However, they can also be added to the isocyanate component or as a combination both to the polyol component and to the isocyanate component.

Catalyst E)

As catalyst E), it is possible to use all compounds which accelerate the reaction of the compounds containing hydroxyl groups and with the modified or unmodified polyisocyanates. Such compounds are known and are described, for example, in “Kunststoffhandbuch, volume 7, Polyurethane”, Carl Hanser Verlag, 3rd edition 1993, chapter 3.4.1. These comprise amine-based catalysts and catalysts based on organic metal compounds.

As catalysts based on organic metal compounds, it is possible to use, for example, organic tin compounds such as tin(II) salts of organic carboxylic acids, e.g. tin(II) acetate, tin(II) octoate, tin(II) ethylhexanoate and tin(II) laurate, and the dialkyltin(IV) salts of organic carboxylic acids, e.g. dibutyltin diacetate, dibutyltin dilaurate, dibutyltin maleate and dioctyltin diacetate, and also bismuth carboxylates, e.g. bismuth(III) neodecanoate, bismuth 2-ethylhexanoate and bismuth octanoate, or alkali metal salts of carboxylic acids, e.g. potassium acetate or potassium formate.

Preference is given to using amine-based catalysts as catalyst E), such as N,N,N′,N′-tetramethyldipropylenetriamine, 2-[2-(dimethylamino)ethyl-methylamino]ethanol, N,N,N′-trimethyl-N′-2-hydroxyethyl-bis-(aminoethyl)ether, bis(2-dimethylaminoethyl) ether, N,N,N,N,N-pentamethyldiethylenetriamine, N,N,N-triethylaminoethoxyethanol, dimethylcyclohexylamine, trimethyl hydroxyethyl ethylenediamine, dimethylbenzylamine, triethylamine, triethylenediamine, pentamethyldipropylenetriamine, dimethylethanolamine, N-methylimidazole, N-ethylimidazole, tetramethylhexamethylenediamine, tris(dimethylaminopropyl)hexahydrotriazine, dimethylaminopropylamine, N-ethylmorpholine, diazabicycloundecene and diazabicyclononene.

It is preferred to use a mixture of two or more of the aforementioned catalysts. The amount of catalyst E), based on the total weight of the reactant B) to F), is preferably from 1 to 10% by weight, particularly preferably from 2 to 6% by weight.

Additives and/or Auxiliaries F)

Additives and/or auxiliaries F) that can be used comprise surfactants, cell regulators, flame retardants, colorants, antioxidants, reinforcing agents, stabilizers and other fillers. In preparing polyurethane foam, it is generally highly preferred to employ a minor amount of a surfactant to stabilize the foaming reaction mixture until it cures. Such surfactants advantageously comprise a liquid or solid organosilicone surfactant, which is employed in amounts sufficient to stabilize the foaming reaction mixture. Typically, the amount of auxiliaries, especially surfactants, is preferably from 0 to 2% by weight, more preferably from 0.5 to 2% by weight, most preferably from 0.6 to 1.5% by weight, based on the total weight of the resin components.

Further information concerning the mode of use and of action of the abovementioned auxiliaries and additives, and also further examples, are given by way of example in “Kunststoffhandbuch, Band 7, Polyurethane” [“Plastics handbook, volume 7, Polyurethanes” ], Carl Hanser Verlag, 3rd edition 1993, chapter 3.4.

The rigid polyurethane foams are advantageously produced by the one-shot process, for example using the high-pressure or low-pressure technique in open or closed molds, for example metallic molds. It is also customary to apply the reaction mixture in a continuous manner to suitable belt lines to produce panels. The starting components are, at a temperature from 15° C. to 90° C., preferably from 20° C. to 60° C. and especially from 20° C. to 35° C., mixed and introduced into an open mold or, if necessary, under superatmospheric pressure, into a closed mold. Mixing, as already noted, can be carried out mechanically using a stirrer or a stirring screw. Mold temperature is advantageously in the range from 20° C. to 110° C., preferably in the range from 30° C. to 70° C. and especially in the range from 40° C. to 60° C.

The polyurethane rigid foam obtained by the present invention has a foam density between 25 and 47 Kg/m³, measured according to DIN EN ISO 845, compressive strength between 100 and 250 KPa, measured according to ISO 844 and thermal conductivity between 18 and 19.2 mw/m*k, measured according to ASTM C518.

The present invention further provides use of the polyurethane rigid foam according to the invention in the application of insulation and appliances.

### Example

The present invention will now be described with reference to Examples and Comparative Examples, which are not intended to limit the present invention.

The following starting materials were used:

Isocyanate:
4,4′-diphenylmethane diisocyanate (MDI), commercially available under trade name Lupranat® M20S from BASF

Polyether Polyol:
Polyol 1: sugar started polyether polyol from BASF with Fn=5, OH number: ˜450 mg KOH/g; Molecular weight: ˜625
Polyol 2: ortho-TDA started polyether polyol from BASF, OH number: ˜400 mg KOH/g; Molecular weight: ˜560
Polyol 3: long chain polyether polyol from BASF, OH number: ˜168 mg KOH/g; Molecular weight: ˜1000
Polyol 4: TEOA started, PO based polyether polyol from BASF, OH number: ˜360 mg KOH/g; Molecular weight: ˜470
Polyol 5: glycerine started, PO based polyether polyol from BASF, OH number: ˜400 mg KOH/g; Molecular weight: ˜420
Polyol 6: trimethylolpropane started polyether polyol, OH number: ˜550 mg KOH/g; Molecular weight: ˜305

Polyester Polyol:
NGPS-3523: low functionality polyester polyol Supplied by Zhangjiagang Nanguang Chemical with Fn=2.3, PA based polyester polyol, OH number 330 mg KOH/g; Molecular weight: ˜390

Polyetherester Polyol:
Polyol 7: synthesized by reactants of phthalic anhydride, glycerine and Polyol 4, OH number: ˜400 mg KOH/g; Molecular weight: ˜561; Fn=4
Polyol 8: synthesized by reactants of phthalic anhydride, glycerine, Polyol 6 and Lupranol 3300, OH number: ˜400 mg KOH/g; Molecular weight: ˜561; Fn=4
Polyol 9: synthesized by reactants of terephthalic acid, glycerine and and Lupranol Polyol 4, OH number: ˜400 mg KOH/g; Molecular weight: ˜561; Fn=4

Surfactant:
BL6864: silicone surfactant

Catalyst,
Cat 1: N,N-dimethylcyclohexylamine, CAS No: 98-94-2
Cat 2: pentamethyldiethylenetriamine, CAS No: 3030-47-5
Cat 3: Triazine catalyst, CAS No: 15875-13-5

Blowing Agent:
Deionized water
Cyclopentane (c-Pentane)

The following methods were used to determine properties:
Cream time: The time of starting rising after polyol and isocyanate mixed
Gel time: measured using an iron stick. Gel time was recorded as the time at which the foam undergoing reaction sticks to the iron stick to form strings when the iron stick is removed from the foam mass.

Demolding Behavior Demolding behavior was determined by measuring the postexpansion of foam bodies produced using a 700×400×90 mm box mold at a mold temperature of 45±2° C. and demolding time of 3.5 min. Postexpansion was determined by measuring the foam thickness after demolding. Higher foam thickness, worse demolding performance.

CP compatibility: mix pentane into polyol blend with the amounts which was reported in the examples, keep the mixture for 1 day/2 weeks at 15° C., check if any phase separation.

Free Rise Density (FRD): The density measured from a 100×100×100 mm block, obtained from the center of a free rising foam (at ambient air-pressure) produced from a total system formulation weight of 300 grams or more. FRD is reported in kg/m3.
Foam density: DIN EN ISO 845
Compressive strength: ISO 844
Thermal conductivity: GB/T 8626-2007

Polyetherester Polyol Synthesis Procedure:

Weigh and add raw material into the flask according to formulation in the following Table 1.

Then stirrer at the speed of 200 rpm and keep the whole system flushed with nitrogen.

The reaction temperature was increased stepwise to 220° C. to maintain distillation of the formed water. Around 90% of the total water is distilled under these conditions.

In the second stage of the poly-esterification reaction the pressure is decreased step by step from 1000 mbar to 100 mbar. During this stage the poly-esterification catalyst can be added to help the water elimination as much as possible.

The evolution of the poly-esterification reaction is monitored by measuring the quantity of water distilled and by the determination of acid number, hydroxyl number and viscosity.

Finally, the resulting polyetherester polyol is filtered and stabilized with acid scavengers of epoxies or carbodiimides.

TABLE 1

| Reactant (weight by | | | |
|---|---|---|---|
| percentage %) | Polyol 7 | Polyol 8 | Polyol9 |
| Phthalic anhydride | 25.57 | 25.50 | — |
| Terephthalic acid | — | — | 25.57 |
| Glycerine | 21.35 | 15.85 | 21.35 |
| Polyol 4 | 53.08 | — | 53.08 |
| Polyol 5 | — | 21.75 | — |
| Polyol 6 | — | 36.90 | — |

Table 2 below lists Comparative Examples 1-3, which include various polyols but exclude polyetherester polyol in Comparative Examples 1 and Comparative Examples 2. Comparative Examples 2 contains an additional polyester polyol with low functionality compared to Comparative Examples 1. Comparative Examples 3 contains a polyetherester polyol which the reactants contain trimethylolpropane/glycerine started polyether polyol non-N contained starter. All numbers are represented in weight by part.

Examples 1-3 include a polyetherester polyol Polyol 7 with different weight by part. The Polyol 7 is TEOA initiated and reacted with phthalic anhydride. Example 4 contains another polyetherester polyol Polyol 9, which is TEOA initiated and reacted with terephthalic acid.

All compositions were prepared according to the components provided in Table 2. The polyol compositions, including additives and blowing agents, were mixed using an air mixer at 2000 rpm until a homogenous liquid was obtained. The polyol mixture was then loaded into a high-pressure machine tank and mixed with the requisite amount of the reported isocyanate (i.e., Lupranat® M20S) to obtain an isocyanate index (unless otherwise stated) of 115. The reaction mixture was injected into molds temperature regulated to 40° C. and measuring 400 mm×700 mm×90 mm and allowed to foam up therein.

TABLE 2

| | Example | | | | | | |
|---|---|---|---|---|---|---|---|
| | Comparative | Comparative | Comparative | | | | |
| | Example1 | Example2 | Example3 | Example 1 | Example 2 | Example 3 | Example 4 |
| Polyol 1 | 50 | 50 | 50 | 50 | 50 | 50 | 50 |
| Polyol 2 | 45 | 25 | 25 | 35 | 25 | 15 | 25 |
| Polyol 7 | — | — | — | 10 | 20 | 30 | — |
| Polyol 8 | — | — | 20 | — | — | — | — |
| Polyol 9 | — | — | — | — | — | — | 20 |
| NGPS3523 | — | 20 | — | — | — | — | — |
| Polyol 3 | 5 | 5 | 5 | 5 | 5 | 5 | 5 |
| BL 6864 | 3 | 3 | 3 | 3 | 3 | 3 | 3 |
| Cat 1 | 1.3 | 1.3 | 1.2 | 1.3 | 1.3 | 1.3 | 1.3 |
| Cat 2 | 0.4 | 0.4 | 0.45 | 0.4 | 0.4 | 0.4 | 0.45 |
| Cat 3 | 0.3 | 0.3 | 0.3 | 0.3 | 0.3 | 0.3 | 0.3 |
| Water | 2.2 | 2.2 | 2.2 | 2.2 | 2.2 | 2.2 | 2.2 |
| c-Pentane | 16.5 | 18.5 | 16.5 | 16.5 | 16.5 | 16.5 | 16.5 |
| Total of polyol compositions | 123.7 | 125.7 | 123.65 | 123.7 | 123.7 | 123.7 | 123.75 |
| NCO index (react with | 115 | 115 | 115 | 115 | 115 | 115 | 115 |
| Lupranat ® M20S) | | | | | | | |
| Cream time (s) | 10 | 10 | 9 | 10 | 11 | 11 | 9 |
| Gel time (s) | 52 | 52 | 54 | 52 | 53 | 54 | 54 |
| FRD - core (kg/m3) | 22.6 | 22.5 | 22.9 | 22.8 | 23.2 | 22.7 | 23 |
| Foam density (kg/m3) | 30.4 | 29.3 | 30.8 | 30.3 | 30.2 | 30.3 | 30.3 |
| Compressive strength (KPa) | 100 | 117 | 115 | 110 | 115 | 120 | 120 |
| Thermal conductivity | 19.23 | 18.96 | 19.02 | 19.08 | 18.82 | 18.92 | 19.07 |
| (mw/m*k) | | | | | | | |
| Demoulding Behavior 3.5 min | 91.45 | 95.24 | 93.5 | 92.15 | 93.67 | 93.6 | 92.1 |
| (mm) | | | | | | | |
| CP compatibility | Good | Bad | Good | Good | Good | Good | Good |
| (15° C., 1 day) | | | | | | | |
| CP compatibility | Good | Bad | Bad | Good | Good | Good | Good |
| (15° C., 2 weeks) | | | | | | | |

It can be seen from the Table 2 that, Comparative Examples 1 containing the ortho-TDA initiated polyether polyol exhibits compressive strength of 100 KPa and thermal conductivity of 19.23 mw/m*k, compared to the Comparative Example 2, the latter shows a higher compressive strength of 117 KPa and lower thermal conductivity of 18.96 mw/m*k. When used as a heat insulation material in the application, the lower thermal conductivity, the better heat insulation performance. Comparative Examples 2 containing a low functionality polyester polyol exhibits bad demolding performance and bad CP compatibility, which leads to a bad processing property which restrict the manufacturing. Comparative Examples 3 containing polyetherester polyol with no starter of alcoholamine or amine-initiated polyether polyol, exhibits compressive strength of 115 kPa and thermal conductivity of 19.02 mw/m*k, however, have bad CP compatibility (15° C., 2 weeks). Example 1, 2 and 3 contain polyetherester polyol, reacted from TEOA initiated polyether polyol and phthalate anhydride. Comparing with Comparative Examples 1, the testing data of example 1, 2 and 3 show improved thermal conductivity and compressive strength, meanwhile keeping same CP compatibility. Comparing with Comparative Examples 2, example 1, 2 and 3 show improved demolding performance. Example 4 (polyetherester polyol synthesized from TEOA initiated polyether polyol and terephthalate acid) shows same performance as example 1, 2 and 3.

The structures, materials, compositions, and methods described herein are intended to be representative examples of the invention, and it will be understood that the scope of the invention is not limited by the scope of the examples. Those skilled in the art will recognize that the invention may be practiced with variations on the disclosed structures, materials, compositions, and methods, and such variations are regarded as within the ambit of the invention. Thus, it is intended that the present invention cover such modifications and variations as come within the scope of the appended claims and their equivalents.

1: A polyetherester polyol, synthesized by reactants comprising:
a) aromatic acid or aromatic anhydride or a mixture thereof, and
b) OH-functional starter molecules,
wherein the OH-functional starter molecules b) comprise alcoholamine or amine-initiated polyether polyol.

2: The polyetherester polyol according to claim 1, wherein the alcoholamine is aliphatic alkanolamine.

3: The polyetherester polyol according to claim 2, wherein the aliphatic alkanolamine is selected from the group consisting of ethanolamine, diethanolamine, triethanolamine, triisopropanolamine, diisopropanolamine, and monoisopropanolamine.

4: The polyetherester polyol according to claim 1, wherein the amine-initiated polyether polyol is an aliphatic amine-initiated polyether polyol.

5: The polyetherester polyol according to claim 4, wherein the aliphatic amine is selected from the group consisting of ethylenediamine, diethylenetriamine, triethylenetetramine, and tetraethylenepentamime.

6: The polyetherester polyol according to claim 1, wherein the aromatic acid is phthalic acid and the aromatic anhydride is phthalic anhydride.

7: The polyetherester polyol according to claim 1, wherein the OH-functional starter molecules (b) further comprise other glycol, glycerin or polyether polyol.

8: The polyetherester polyol according to claim 1, wherein a molar ratio of reactant a) to reactant b) is from 1:1 to 1:3.

9: The polyetherester polyol according to claim 1, wherein the polyetherester polyol has an average functionality of at least 3 and an OH number of 50 to 800 mg KOH/g.

10: A process for producing rigid polyurethane foams, the process comprising:
reacting
A) organic or modified organic di- or polyisocyanates or a mixture thereof,
B) one or more polyetherester polyols according to claim 1,
C) optionally, further polyester and/or polyether polyols,
D) one or more blowing agents,
E) catalysts, and
F) optionally, further auxiliaries and/or additives.

11: A rigid polyurethane foam, obtained by the process according to claim 10.

12: A rigid polyurethane foam, made using the polyetherester polyol according to claim 1.

13: The rigid polyurethane foam according to claim 11, wherein the rigid polyurethane foam is an insulation or a foam in an appliance application.

14: The polyetherester polyol according to claim 8, wherein the molar ratio of reactant a) to reactant b) is from 1:1 to 1:2.

15: The polyetherester polyol according to claim 9, wherein the polyetherester polyol has an OH number of 300 to 500 mg KOH/g.
